(19) United States
(12) Patent Application Publication
(10) Pub. No.: US 2012/0311446 A1
(43) Pub. Date: Dec. 6, 2012

(54) CONTENT RECORDING DEVICE, CONTENT RECORDING METHOD, CONTENT RECORDING PROGRAM, RECORDING MEDIUM, INTEGRATED CIRCUIT AND CONTENT RECORDING AND REPRODUCTION SYSTEM

(76) Inventors: Toshihisa Nakano, Osaka (JP); Masataka Minami, Hyogo (JP); Masayuki Kozuka, Osaka (JP)

(21) Appl. No.: 13/578,060

(22) PCT Filed: Apr. 8, 2011
(86) PCT No.: PCT/JP2011/002097

§ 371 Date: Aug. 9, 2012

(30) Foreign Application Priority Data
Apr. 13, 2010 (JP) 2010-092165

(51) Int. Cl. G06F 3/048

(52) U.S. Cl. 715/716

(57) ABSTRACT

A content recording device includes: an input/output unit 201 that reads, from a first recording medium, content and default playback auxiliary information used to generate a default menu screen for playing back the content; a playback unit 203 that includes a first display mechanism for generating the default menu screen by using the default playback auxiliary information and displaying the generated default menu screen; a transmission/reception unit 208 that acquires, from outside, additional playback auxiliary information used to generate an additional menu screen different from the default menu screen and displayable by a second display mechanism; and a storage unit 202 that writes the content and the default playback auxiliary information into a second recording medium and further writes, via the input/output unit 201, the additional playback auxiliary information into a predetermined reading location from which a playback device including the second display mechanism reads the additional playback auxiliary information.

### TECHNICAL FIELD

The present invention relates to technology for taking out digital content held in a content recording device by writing the digital content into a recording medium, and in particular to playback of the taken-out digital content.

### BACKGROUND ART

In recent years, package media manufactured by recording digital content (hereinafter, referred to as “content”) on high-capacity Blu-ray Discs™ have been widely distributed in the market. Such package media employ advanced menu screens used to encourage users to start up content. Compared to menu screens employed in DVD (Digital Versatile Disc)-VIDEO, the menu screens employed by such package media achieve more expressive and interactive displays. A playback device usually reads content and information used to generate a menu screen (playback auxiliary information) from a package media, generates the menu screen by using the read information, and plays back the content in accordance with input operation performed by a user with reference to the menu screen. As another example, there is a case where the playback device once stores the read content and playback auxiliary information in a built-in HDD (Hard Disc Drive), and then the stored content and playback auxiliary information are taken out by being recorded on another portable recording medium and the like while ensuring consistency of a protection (an encryption) scheme (see Patent Literature 1.) The content and the like taken out by using the portable recording medium and the like are played back, for example, by an information processing terminal.

### CITATION LIST

### Patent Literature

[Patent Literature 1]
Japanese Patent Application Publication No. 2004-311000

### SUMMARY OF INVENTION

### Technical Problem

Information processing capability of an information processing terminal, in particular a portable information processing terminal, is kept lower than that of a stationary playback device because reduction in power consumption is required for such a terminal. Therefore, such a terminal often does not include a display mechanism having high processing capability required in a Java™ environment for achieving an advanced menu screen and the like.

In this case, if a portable recording medium having recorded thereon the above-mentioned content and playback auxiliary information is played back by a playback device, it is possible to display a menu screen generated by using the playback auxiliary information. If the portable recording medium is played back by an information processing terminal having low processing capability, however, there are such problems that the menu screen cannot be displayed and thus the content cannot be played back by simple procedures performed by a user with reference to the menu screen.

### Solution to Problem

In order to solve the above-presented problems, a content recording device as one aspect of the present invention is a content recording device that records, on a recording medium, content and first playback auxiliary information used to generate a default menu screen for playing back the content, the content recording device comprising: a content acquisition unit configured to acquire the content and the first playback auxiliary information; a playback auxiliary information acquisition unit configured to acquire second playback auxiliary information used to generate a substitute menu screen displayable by a display mechanism different from a display mechanism for displaying the default menu screen; and a writing unit configured to write the content and the first playback auxiliary information into the recording medium, and further write the second playback auxiliary information into a reading location on the recording medium from which a playback device including the different display mechanism reads the second playback auxiliary information.

### Advantageous Effects of Invention

With the above-mentioned configuration, the content recording device as one aspect of the present invention records the content on the recording medium so that the content can easily be played back by a playback device that does not include a display mechanism for displaying the default menu screen, using an additional menu screen generated by using an additional playback auxiliary information.

For example, when a portable information processing terminal, whose information processing capability is generally kept lower than that of a stationary playback device since reduction in power consumption is required for such an information processing terminal, includes a simple display mechanism instead of including a display mechanism having high processing capability required in the Java environment for achieving an advanced menu screen and the like, the portable information processing terminal displays the additional menu screen supported by the simple display mechanism and generated by using the additional playback auxiliary information so that a user can easily play back content. Therefore, convenience of a user is improved.

### BRIEF DESCRIPTION OF DRAWINGS

FIG. 1 is a block diagram illustrating a configuration of a content providing system pertaining to an embodiment of the present invention.

FIG. 2 is a block diagram illustrating a configuration of a playback/recording device pertaining to the embodiment of the present invention.

FIG. 3 is a block diagram illustrating a configuration of a playback device pertaining to the embodiment of the present invention.

FIG. 4 is a flow chart showing processing to store, in a built-in HDD, content having been recorded on a recording medium pertaining to the embodiment of the present invention.

FIG. 5 is a flow chart showing processing to write, into a recording medium, content recorded on an HDD pertaining to the embodiment of the present invention.

FIG. 6 is a flow chart showing processing to playback content having been recorded on a recording medium pertaining to the embodiment of the present invention.

FIG. 7 illustrates a configuration of an LSI for achieving functions of the playback/recording device pertaining to the embodiment of the present invention.

FIG. 8A illustrates an example of a configuration of data having been recorded on a recording medium from which the data is to be read pertaining to the embodiment of the present invention. FIG. 8B illustrates an example of a configuration of data having been recorded on a recording medium used to take out the data pertaining to the embodiment of the present invention.

FIG. 9 schematically illustrates data having been stored in an HDD 217 pertaining to the embodiment of the present invention.

FIG. 10 illustrates an example of use condition information pertaining to the embodiment of the present invention.

FIG. 11 illustrates an example of a default menu screen pertaining to the embodiment of the present invention.

FIG. 12 illustrates an example of an additional menu screen pertaining to the embodiment of the present invention.

### DESCRIPTION OF EMBODIMENTS

A content recording device as one aspect of the present invention is a content recording device that records, on a recording medium, content and first playback auxiliary information used to generate a default menu screen for playing back the content, the content recording device comprising: a content acquisition unit configured to acquire the content and the first playback auxiliary information; a playback auxiliary information acquisition unit configured to acquire second playback auxiliary information used to generate a substitute menu screen displayable by a display mechanism different from a display mechanism for displaying the default menu screen; and a writing unit configured to write the content and the first playback auxiliary information into the recording medium, and further write the second playback auxiliary information into a reading location on the recording medium from which a playback device including the different display mechanism reads the second playback auxiliary information.

A processing load of displaying the substitute menu screen generated by using the second playback auxiliary information may be less than a processing load of displaying the default menu screen generated by using the first playback auxiliary information.

According to this configuration, an additional menu screen generated by using additional playback auxiliary information is displayed by a playback device that can only perform display processing with a load less than the load of displaying the default menu screen, so that content can easily be played back by the playback device.

The default menu screen generated by using the first playback auxiliary information may be more interactive than the substitute menu screen generated by using the second playback auxiliary information, and the substitute menu screen generated by using the second playback auxiliary information may be used to display a list of content pieces available for playback, receive selection of one content piece from the list, and non-interactively play back the one content piece.

According to this configuration, the playback device plays back content while reducing a load on a playback device by using a menu screen that is less interactive and simpler than the default menu screen when content to be played back is selected.

The playback auxiliary information acquisition unit may generate the second playback auxiliary information to acquire the second playback auxiliary information.

According to this configuration, the additional menu screen is displayed by acquiring the additional playback auxiliary information even in an environment in which the content recording device is not connected to the network and the like.

The playback auxiliary information acquisition unit may further acquire one or more other playback auxiliary information pieces, and the content recording device may further comprise: a display unit configured to display a list of all the playback auxiliary information pieces acquired by the playback auxiliary information acquisition unit; and a reception unit configured to receive, from a user, an instruction specifying one or more playback auxiliary information pieces to be written into the recording medium from the list, and the writing unit may write the specified one or more playback auxiliary information pieces into the recording medium.

According to this configuration, the probability that the playback device displays a menu screen is increased when content recorded on the recording medium is played back.

The content acquisition unit may further acquire one or more other content pieces, and the content recording device may further comprise: a format checking unit configured to check a format of each of all the acquired content pieces; and a management unit configured to manage the acquired content pieces by newly attaching a same use condition to content pieces in a same format irrespective of whether or not a use condition has been attached to each of the acquired content pieces.

According to this configuration, content is used according to the same use condition without individually identifying a use condition of each content piece. Therefore, convenience of a user is improved.

A content recording method as another aspect of the present invention is a content recording method for recording, on a recording medium, content and first playback auxiliary information used to generate a default menu screen for playing back the content, the content recording method comprising: a content acquisition step of acquiring the content and the first playback auxiliary information; a playback auxiliary information acquisition step of acquiring second playback auxiliary information used to generate a substitute menu displayable by a display mechanism different from a display mechanism for displaying the default menu screen; and a writing step of writing the content and the first playback auxiliary information into the recording medium, and further writing the second playback auxiliary information into a reading location on the recording medium from which a playback device including the different display mechanism reads the second playback auxiliary information.

A content recording program as yet another aspect of the present invention is a content recording program for use by a content recording device that records, on a recording medium, content and first playback auxiliary information used to generate a default menu screen for playing back the content, the content recording program comprising: a content acquisition step of acquiring the content and the first playback auxiliary information; a playback auxiliary information acquisition step of acquiring second playback auxiliary information used to generate a substitute menu displayable by a display mechanism different from a display mechanism for displaying the default menu screen; and a writing step of writing the content and the first playback auxiliary information into the recording medium, and further writing the second playback auxiliary information into a reading location on the recording medium from which a playback device including the different display mechanism reads the second playback auxiliary information.

A recording medium as yet another aspect of the present invention is a computer-readable recording medium having recorded thereon a content recording program for use by a content recording device that records, on a recording medium, content and first playback auxiliary information used to generate a default menu screen for playing back the content, wherein the content recording program comprising: a content acquisition step of acquiring the content and the first playback auxiliary information; a playback auxiliary information acquisition step of acquiring second playback auxiliary information used to generate a substitute menu displayable by a display mechanism different from a display mechanism for displaying the default menu screen; and a writing step of writing the content and the first playback auxiliary information into the recording medium, and further writing the second playback auxiliary information into a reading location on the recording medium from which a playback device including the different display mechanism reads the second playback auxiliary information.

An integrated circuit as yet another aspect of the present invention is an integrated circuit that records, on a recording medium, content and first playback auxiliary information used to generate a default menu screen for playing back the content, the integrated circuit comprising: a content acquisition unit configured to acquire the content and the first playback auxiliary information; a playback auxiliary information acquisition unit configured to acquire second playback auxiliary information used to generate a substitute menu screen displayable by a display mechanism different from a display mechanism for displaying the default menu screen; and a writing unit configured to write the content and the first playback auxiliary information into the recording medium, and further write the second playback auxiliary information into a reading location on the recording medium from which a playback device including the different display mechanism reads the second playback auxiliary information.

A content recording/playback system as yet another aspect of the present invention is a content recording/playback system including a content recording device and a playback device, wherein the content recording device comprising: a content acquisition unit configured to acquire the content and the first playback auxiliary information used to generate a default menu screen for playing back the content; a playback auxiliary information acquisition unit configured to acquire second playback auxiliary information used to generate a substitute menu screen displayable by a display mechanism different from a display mechanism for displaying the default menu screen; and a writing unit configured to write the content and the first playback auxiliary information into the recording medium, and further write the second playback auxiliary information into a reading location on the recording medium from which a playback device including the different display mechanism reads the second playback auxiliary information, and the playback device includes the different display mechanism, and reads the second playback auxiliary information from the recording medium and displays the substitute menu screen generated by using the read second playback auxiliary information.

According to this configuration, the content is recorded on the recording medium so as to be easily played back by a playback device that does not include the display mechanism for displaying the default menu screen, using the additional menu screen generated by using the additional playback auxiliary information. For example, when a portable information processing terminal, whose information processing capability is generally kept lower than that of a stationary playback device since reduction in power consumption is required for such an information processing terminal, includes a simple display mechanism instead of including a display mechanism having high processing capability required in the Java environment for achieving an advanced menu screen and the like, the portable information processing terminal displays the additional menu screen that is supported by the simple display mechanism and generated by using the additional playback auxiliary information so that a user can easily play back content. Therefore, convenience of a user is improved.

The following describes an embodiment of the present invention, with reference to the drawings.

1. Configuration

1.1. Overview of Content Providing System

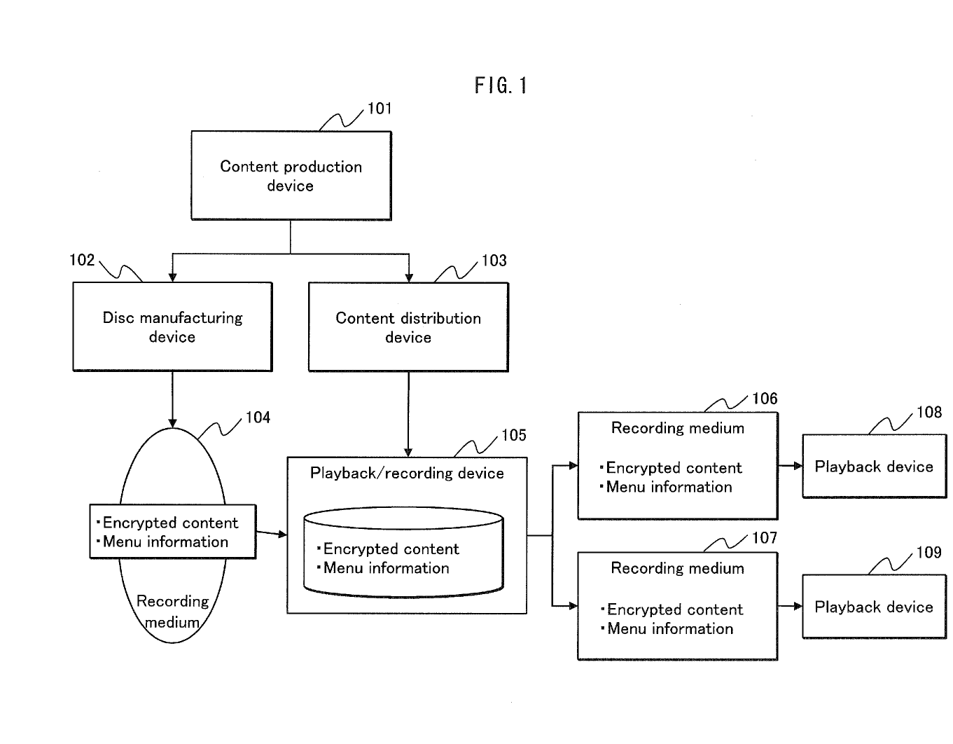

FIG. 1 illustrates a configuration of a content providing system pertaining to the embodiment of the present invention.

As illustrated in FIG. 1, the content providing system pertaining to the embodiment of the present invention includes a content production device 101, a disc manufacturing device 102, a content distribution device 103, a recording medium 104, a playback/recording device 105, a recording medium 106, a recording medium 107, a playback device 108 and a playback device 109.

The content production device 101 produces content, for example, by editing, processing and data compressing a moving picture, audio and the like that are taken as materials of the content by a movie company and the like. The content production device 101 also generates playback auxiliary information (hereinafter, referred to as “default playback auxiliary information”) used to generate a default menu screen for playing back the content. The content production device 101 provides the generated content and default playback auxiliary information for the disc manufacturing device 102 and the content distribution device 103. In the present embodiment, the default menu screen complies with the BD-J™ (Blu-ray Disc Java) specification. The default menu screen is programmed by Java to have advanced interactive functions including complicated moving picture processing and network cooperation. The default menu screen is displayed only by a playback device including a display mechanism capable of interpreting a Java program and having high information processing capability.

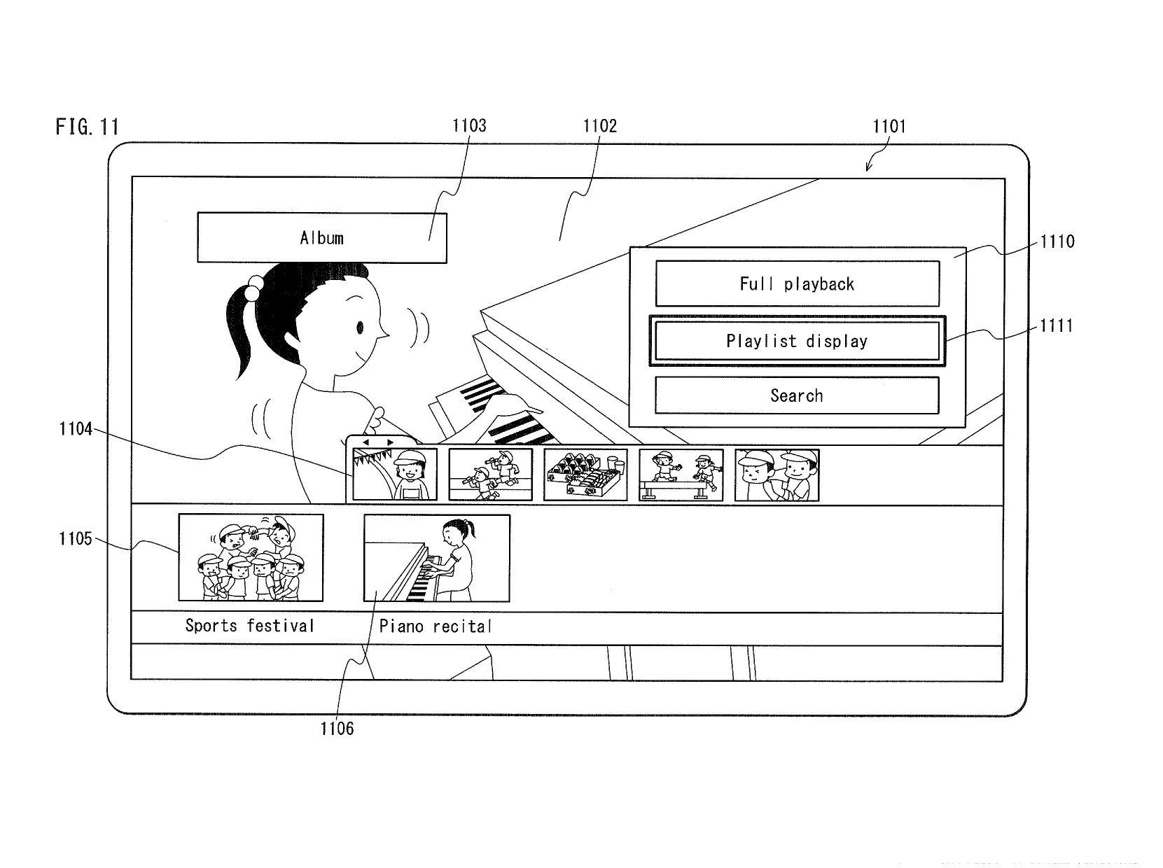

FIG. 11 illustrates an example of an image displayed on a display screen as the default menu screen.

In a default menu screen 1101, a title 1103 “album”, a menu 1110, and images 1104 to 1106 as thumbnail moving pictures are superimposed on a background moving picture 1102. A user selects desired operation from among “full playback”, “playlist display”, “search” and the like by moving a cursor 1111 on the menu 1110.

The default menu screen 1101 is used to display an advanced menu as described above and achieve a highly interactive display so that a user can select and perform various types of operation using the default menu screen 1101.

The content production device 101 provides the produced content and default playback auxiliary information for the disc manufacturing device 102 and the content distribution device 103.

The disc manufacturing device 102 manufactures package software. Specifically, the disc manufacturing device 102 manufactures the package software by receiving the content and the default playback auxiliary information from the content production device 101, encrypting the received content and playback auxiliary information in accordance with a predetermined copyright protection scheme (hereinafter, referred to as a “protection scheme”) for a disc for recording, and recording the encrypted content and playback auxiliary information on a recording medium 104 as the disc for recording. In the present embodiment, by way of example, the recording medium 104 is a Blu-ray disc.

The protection scheme here is a scheme to protect content and the like, and is, for example, an encryption algorithm and a key encryption scheme. The protection scheme is determined according to a type of a recording medium on which data is to be recorded. In the present embodiment, as the protection scheme, AACS (Advanced Access Content System) is used when data is to be recorded on a BD, CPRM (Content Protection for Recordable Media) is used when data is to be recorded on an SD card or a DVD, and AES (Advanced Encryption Standard) is used when data is to be recorded on an HDD.

The content distribution device 103 is a server device that provides a content distribution service. The content distribution device 103 receives the content and the default playback auxiliary information from the content production device 101, and transmits the received content and default playback auxiliary information to the playback/recording device 105 using a protection scheme determined in advance with respect to the distribution service.

When transmitting the received content and default playback auxiliary information, the content distribution device 103 adds use condition information indicating a use condition to part or whole of the content. The use condition information is used to restrict use of the content, and is determined in advance with respect to the distribution service. The use condition information includes, for example, at least one of a content usable period, the number of copies, a possibility of taking out content and the number of taking out content. The use condition information is used by a playback device for playing back content to determine whether or not the content is allowed to be played back.

Apart from the default playback auxiliary information received from the content production device 101, the content distribution device 103 independently generates playback auxiliary information (hereinafter, referred to as “additional playback auxiliary information”) corresponding to the received content. The generated additional playback auxiliary information is distributed to the playback/recording device 105. A menu screen generated by using the additional playback auxiliary information (hereinafter, referred to as an “additional menu screen”) is simpler than the default menu screen, does not require the Java environment for display and has a low display processing load. That is to say, the additional menu screen is displayable by an information processing terminal and the like including a simple display mechanism.

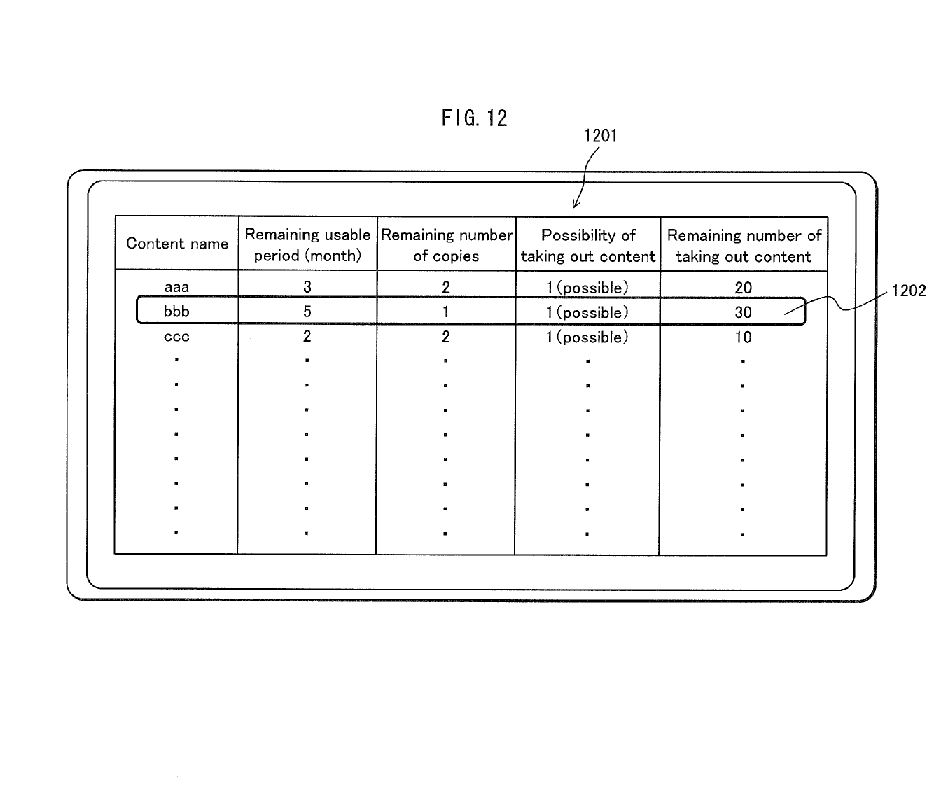

FIG. 12 illustrates an example of the additional menu screen.

An image 1201 pertaining to the additional menu screen merely displays a list of content pieces available for playback. The image 1201 displays, for each content piece, a content name and information concerning use of the content. The information concerning use of the content here includes a remaining usable period (month), the remaining number of copies, a possibility of taking out content and the remaining number of taking out content. A cursor 1202 used to select content is superimposed on the image 1201. A user moves the cursor 1202 to select content from the list. As described above, the additional menu screen is a simple menu screen used to non-interactively play back the selected content, or to copy and take out the selected content. Note that the image 1201 may not display the information concerning use of the content, and may display a list of only content names. Alternatively, the image 1201 may display part of the information concerning use of the content. In the present embodiment, the additional playback auxiliary information complies with the HDMV specification. Note that, in the HDMV specification, a menu screen is composed of a combination of navigation commands and is relatively easily created. Compared to the BD-J specification, however, more limitations are imposed on a menu configuration and the like, and thus the created menu screen is simple. Note that, although the additional menu screen is explained as a simpler menu screen than the default menu screen here, the additional menu screen is not limited in this way. The additional menu screen may be a more advanced menu screen than the default menu screen.

The playback/recording device 105 records and plays back content. The playback/recording device 105 reads the content and the default playback auxiliary information recorded on the recording medium 104, and stores the read content and default playback auxiliary information in a built-in HDD. The playback/recording device 105 also receives the content and the default playback auxiliary information distributed by the content distribution device 103, and stores the received content and default playback auxiliary information in the HDD.

Furthermore, the playback/recording device 105 acquires, from the content distribution device 103, the additional playback auxiliary information concerning the content read from the recording medium 104 or distributed by the content distribution device 103, and stores the acquired additional playback auxiliary information in the HDD. The playback/recording device 105 records the content, the default playback auxiliary information as well as the additional playback auxiliary information on the recording media 106 and 107.

With this configuration, the content recorded on the recording media 106 and 107 is played back, using a menu screen, not only by a playback device capable of processing the default playback auxiliary information but also by a playback device including a simple display mechanism capable of processing only the additional playback auxiliary information. Therefore, convenience of a user is improved.

The playback/recording device 105 also plays back the content stored in the HDD.

The recording medium 106 is, for example, a recordable-type flash memory such as an SD card. The content and the playback auxiliary information are encrypted in accordance with a protection scheme suitable for the recording medium 106 and recorded on the recording medium 106.

The recording medium 107 is, for example, a recordable-type optical disc such as a DVD. The content and the playback auxiliary information are encrypted in accordance with a protection scheme suitable for the recording medium 107 and recorded on the recording medium 107.

The playback device 108 includes a mechanism for reading data from the recording medium 106. The playback device 108 decrypts the encrypted content recorded the recording medium 106 and plays back the decrypted content.

The playback device 109 includes a mechanism for reading data from the recording medium 107. The playback device 109 decrypts the encrypted content recorded on the recording medium 107 and plays back the decrypted content.

The following describes each configuration in detail.

1.2. Playback/recording Device 105

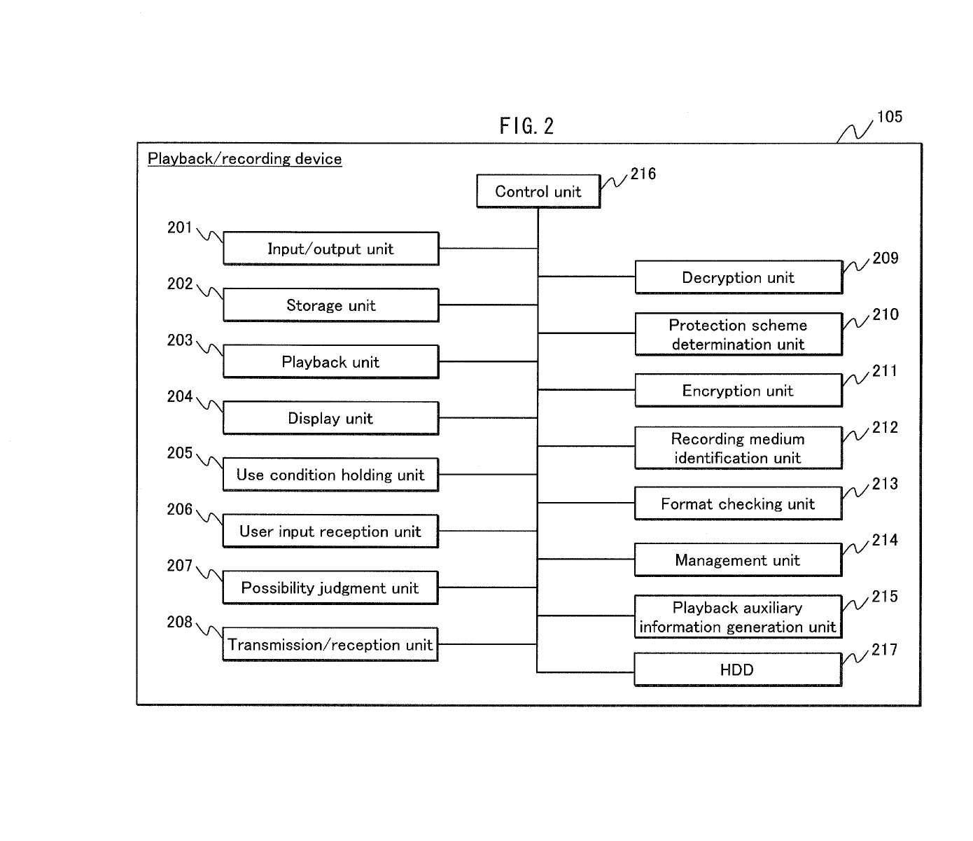

FIG. 2 is a block diagram illustrating a configuration of the playback/recording device 105.

As illustrated in FIG. 2, the playback/recording device 105 includes: an input/output unit 201; a storage unit 202; a playback unit 203; a display unit 204; a use condition holding unit 205; a user input reception unit 206; a possibility judgment unit 207; a transmission/reception unit 208; a decryption unit 209; a protection scheme determination unit 210; an encryption unit 211; a recording medium identification unit 212; a format checking unit 213; a management unit 214; a playback auxiliary information generation unit 215; a control unit 216; and an HDD 217. The input/output unit 201 and the storage unit 202 correspond to a content acquisition unit and a writing unit. The user input reception unit 206 corresponds to a reception unit. The transmission/reception unit 208 and the playback auxiliary information generation unit 215 correspond to a playback auxiliary information acquisition unit.

The display unit 204 includes a display screen and a display control unit (not illustrated) that controls a display on the display screen.

The input/output unit 201 includes a mechanism for reading and writing data from and into a plurality of types of recording media and the like, and reads and writes data from and into these types of recording media and the like.

Specifically, the input/output unit 201 reads, from the recording medium 104, all the encrypted content and playback auxiliary information recorded on the recording medium 104.

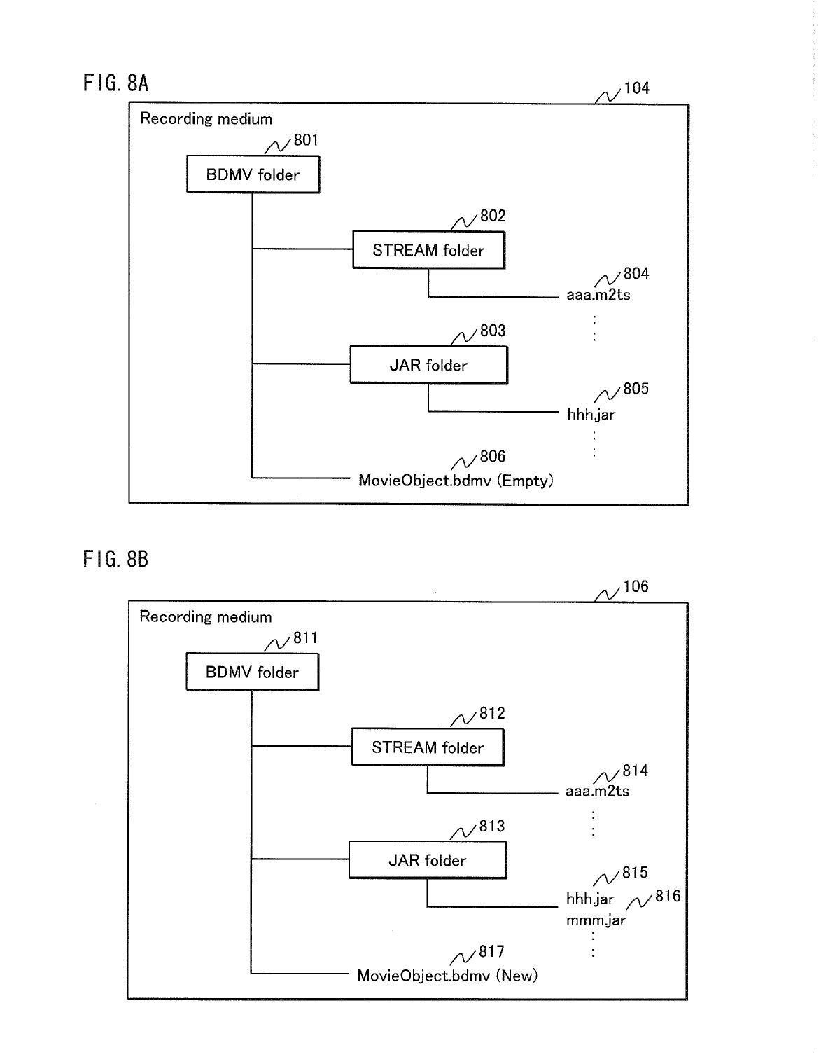

FIG. 8A illustrates an example of a configuration of data recorded on the recording medium 104.

A STREAM folder 802 and a JAR folder 803 are located under a BDMV folder 801. Content is stored in the STREAM folder 802. In the present embodiment, the content is indicated as an aaa.m2ts (804) file. A Java file is stored in the JAR folder 803. In the present embodiment, the Java file is indicated as an hhh.jar (805) file. The Java file corresponds to the above-mentioned default playback auxiliary information. In the playback device, the default menu screen is displayed by running the hhh.jar file. A MovieObject.bdmv (Empty) (806) file is stored in the BDMV folder 801. The MovieObject.bdmv file is information used to generate a simpler menu screen than the default menu screen. In the present embodiment, assume that the MovieObject.bdmv file is recorded on the recording medium 104 at all times due to restrictions on the specification. When the default playback auxiliary information used to generate the default menu screen is stored in the JAR folder, the MovieObject.bdmv file is empty (0 bytes.)

In the case illustrated in FIG. 8A, the input/output unit 201 reads the aaa.m2ts file, the hhh.jar file and the MovieObject.bdmv (Empty) file from the recording medium 104.

As in the case of reading data from the recording medium 104, the input/output unit 201 reads all the encrypted content and playback auxiliary information from other types of recording media. Examples of the other types of recording media here include a DVD disc, an SD card and the like.

The storage unit 202 stores the content and playback auxiliary information read by the input/output unit 201 in the HDD 217. The storage unit 202 also stores all the encrypted content and playback auxiliary information acquired by the transmission/reception unit 208 (described later) in the HDD 217. The storage unit 202 records the encrypted content and the playback auxiliary information stored in the HDD 217 on other recording media such as the recording media 106 and 107 via the input/output unit 201. In this case, the playback auxiliary information is written into predetermined reading locations on the recording media 106 and 107.

FIG. 8B illustrates an example of a configuration of data recorded on the recording medium 106.

The recording medium 106 includes a BDMV folder 811. Under the BDMV folder 811, a STREAM folder 812 and a JAR folder 813 are located. Content is stored in the STREAM folder 812. In the present embodiment, an aaa.m2ts (814) file is written as content. In the JAR folder 813, an hhh.jar (815) file, which is a Java file recorded on the recording medium 104, is written. The hhh.jar file corresponds to the above-mentioned default playback auxiliary information. In the JAR folder 813, an mmm.jar (816) file, which is not recorded on the recording medium 104, is written. The mmm.jar (816) file is the playback auxiliary information acquired from the outside, for example, from the content distribution device 103, and corresponds to the above-mentioned additional playback auxiliary information.

Instead of the MovieObject.bdmv (Empty) file, a MovieObject.bdmv (New) (817) file is stored in the BDMV folder 811 as a substantial file. The MovieObject.bdmv (New) file is the playback auxiliary information acquired from the outside or generated within the device, and corresponds to the above-mentioned additional playback auxiliary information. A simple additional menu screen is displayed by playing back the MovieObject.bdmv (New) file. The MovieObject.bdmv (New) file is written into a predetermined reading location. A playback device that plays back content using the recording medium 106 has learned of the predetermined reading location, and attempts to play back the MovieObject.bdmv (New) file first. Note that the predetermined reading location is a matter of design choice, and may be selected, for example, from a predetermined sector, address or folder on a recording medium.

The use condition holding unit 205 holds therein the use condition information indicating a use condition that restricts use of content, such as a possibility of taking out content, the number of taking out content, the number of copies and a playback available time (a term of validity.) Content is allowed to be played back within a range of the use condition.

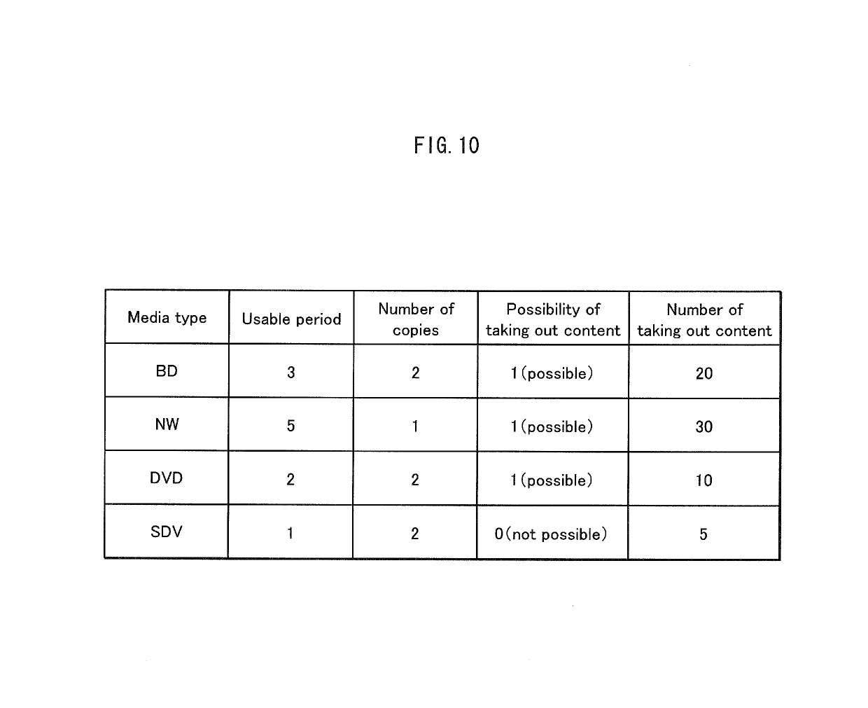

FIG. 10 illustrates an example of the use condition information.

The use condition information includes a media type, a usable period, the number of copies, a possibility of taking out content and the number of taking out content.

The media type indicates a type of a medium from which the content is acquired.

BD, NW, DVD and SDV respectively indicate a Blu-ray Disc, a network, a Digital Versatile Disc and an SD-VIDEO.

The usable period indicates a period during which content is allowed to be used after the content is copied to a medium for recording.

The number of copies indicates the number of times the content is allowed to be copied.

The possibility of taking out content indicates whether or not the content is allowed to be taken out.

Here, the term “taking out content” means a condition in which the playback/recording device is prohibited from playing back the content but the content is not deleted from the playback/recording device, and the content itself is written into a medium for recording and copyright information of the content is taken out. By writing the copyright information back from the medium for recording to the playback/recording device 105, the original content is returned to a state in which playback is possible. With this configuration, even if the quality of content is reduced to write the content into the medium for recording due to limitations on a storage capacity of the medium and the like at the time of taking out the content, the playback/recording device 105 can play back the content having the same quality as the quality before being reduced after the copyright information is written back from the medium for recording.

The number of taking out content indicates the number of times the content is allowed to be taken out.

The use condition information is set in advance with respect to the playback/recording device 105 and held in advance in the playback/recording device 105. When acquiring content from a medium, the playback/recording device 105 removes a use condition attached in advance to the content according to the media type of a medium from which the content is acquired, and adds a new use condition indicated by the use condition information to the acquired content. By way of example, the following describes a case where content whose usable period is determined, by an original use condition, to be two months has been recorded on a BD.

The input/output unit 201 included in the playback/recording device 105 reads the content and the default playback auxiliary information from the BD and causes the storage unit 202 to store the read content and default playback auxiliary information in the HDD 217. In this case, as for the content stored in the HDD 217, the usable period “two months” determined by the original condition is removed, and a usable period “three months” is newly assigned as indicated in a column of the media type “BD” of the use condition information illustrated in FIG. 10.

This eliminates the need for a user using content to pay attention to a great number of use conditions that differ among content pieces. The user has only to pay attention to a use condition assigned to each media type. Therefore, convenience of a user is improved.

Note that those who have added an original use condition to content, such as a producer and a distributor of the content, have concluded in advance a contract and the like indicating approval and permission for the playback/recording device 105 to replace the original use condition with a new use condition.

The playback unit 203 includes a display mechanism for processing the default playback auxiliary information and displaying the default menu screen. Specifically, the playback unit 203 interprets the default playback auxiliary information that complies with the BD-J specification, generates the default menu screen (e.g. the default menu screen 1101) by using the interpreted default playback auxiliary information, and causes the display unit 204 to display the generated default menu screen.

The playback unit 203 plays back content selected, using the default menu screen, by a user instruction. In this case, the playback unit 203 stores usage status information indicating a usage status of the content in the HDD 217 or updates the usage status information. When the usage status of the content shows that the use condition indicated by the above-mentioned use condition information is not satisfied, the playback unit 203 stops using the content.

Items included in the usage status information correspond to the items included in the use condition information. For example, the usage status information includes a use period, the number of copies and the number of taking out content.

The use period here indicates a period during which the content was used after the content was copied to a medium for recording (HDD 217 in this case.)

The number of copies indicates the number of times the content was copied. The number of taking out content indicates the number of times the content was taken out.

When the use period of the content included in the usage status information exceeds the usable period of the content included in the use condition information, the playback unit 203 stops playing back the content.

When the content is taken out, the use condition information and the usage status information of the content are recorded along with the content on a recording medium used to take out the content. A playback device and the like using the recording medium used to take out the content uses the use condition information and the usage status information in a similar manner to the playback unit 203.

The user input reception unit 206 receives an instruction from a user provided through input operation on an input device (not illustrated) such as a keypad, and notifies the control unit 216 of the received instruction. For example, in a state where the display unit 204 displays the default menu screen as illustrated in FIG. 11, a user operates a keypad and the like to select content. The user input reception unit 206 learns the content selected by the user, and notifies the playback unit 203 of the selected content.

The possibility judgment unit 207 judges whether or not the content selected by the user is allowed to be taken out with reference to the use condition information held in the use condition holding unit 205. Specifically, the possibility judgment unit 207 judges that the selected content is allowed to be taken out when a value of the use condition information is “1,” and judges that the selected content is not allowed to be taken out when the value of the use condition information is “0.”

The transmission/reception unit 208 makes a request for content and default playback auxiliary information concerning the content to the content distribution device 103, and receives the content and the default playback auxiliary information concerning the content as a response to the request. The transmission/reception unit 208 stores the received content and default playback auxiliary information concerning the content in the HDD 217.

The transmission/reception unit 208 further makes a request, to the content distribution device 103, for additional playback auxiliary information concerning each content piece stored in the HDD 217, which is different from the default playback auxiliary information acquired along with the content. As a response to the request, the transmission/reception unit 208 acquires one or more additional playback auxiliary information pieces from the content distribution device 103.

For example, as for content that is recorded on the recording medium 104 only in association with the default playback auxiliary information used to generate the menu screen that complies with the BD-J specification, the transmission/reception unit 208 receives, from the content distribution device 103, the additional playback auxiliary information used to generate a menu that complies with the HDMV specification. The transmission/reception unit 208 stores the acquired additional playback auxiliary information in the HDD 217 via the storage unit 202.

The decryption unit 209 decrypts encrypted content in accordance with a corresponding protection scheme.

The protection scheme determination unit 210 determines a protection scheme suitable for a recording medium to read or write content from or into the recording medium.

The encryption unit 211 encrypts content in accordance with the determined protection scheme.

The recording medium identification unit 212 identifies a type of a recording medium such as the recording media 106 and 107. By way of example, the recording medium identification unit 212 classifies recording media targeted for identification into a BD, a DVD, an SD card, a USB memory and an HDD.

The format checking unit 213 checks and identifies an application format (hereinafter, simply referred to as a “format”) of the content. For example, the format is BDMV (Blu-ray Disk Movie) in the case of a Blu-ray disc, DVD-Video in the case of a DVD, and SD-VIDEO in the case of an SD card.

HDD 217 is a high-capacity hard disk for storing therein data such as content.

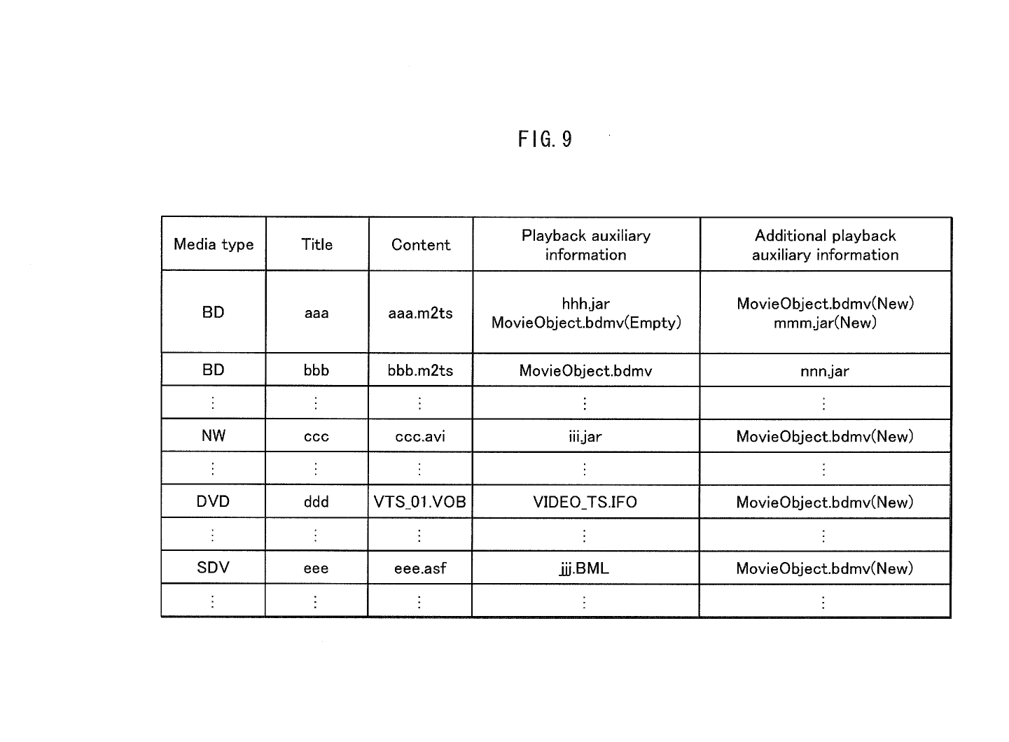

FIG. 9 schematically illustrates data stored in the HDD 217.

Each line in FIG. 9 indicates content information corresponding to one content piece. The content information includes a media type, a title, and additional playback auxiliary information in addition to content itself (file) and one or more playback auxiliary information pieces concerning the content.

The media type is similar to that included in the use condition information illustrated in FIG. 10. The title indicates a title of the content. As the content itself, a file name of the content is written in FIG. 9. The playback auxiliary information indicates playback auxiliary information associated with the content. The additional playback auxiliary information indicates playback auxiliary information that is different from the default playback auxiliary information distributed along with the content and is added after the distribution of the content.

The following describes the content information in detail by taking content information of content whose title is “aaa” (hereinafter, referred to as “content information a”) as an example.

In FIG. 9, content itself whose title is “aaa” is a file (aaa.m2ts) with a file name “aaa.m2ts.” From the media type and the playback auxiliary information respectively indicating “BD” and “hhh.jar, MovieObject.bdmv (Empty)”, it can be understood that the content aaa.m2ts was originally recorded on a BD (hereinafter, the BD having recorded thereon the content whose title is “aaa” is referred to as a “BDa”) along with the hhh.jar file and the MovieObject.bdmv (Empty) file, which are the default playback auxiliary information, and was then read from the BDa and stored in the HDD 217. Here, the word “(Empty)” in the MovieObject.bdmv (Empty) file indicates that a size of the file is 0 and distinguishes the MovieObject.bdmv (Empty) file from the MovieObject.bdmv file whose size is not 0.

In the BDa, two files are recorded as the default playback auxiliary information. Since a size of the MovieObject.bdmv file is 0, however, it is impossible to generate a menu screen by interpreting the MovieObject.bdmv file. The playback unit 203 actually generates the menu screen by interpreting the hhh.jar file. That is to say, in the case of playing back the BDa, a menu screen is displayed only when the playback device has the Java environment.

The content information a also includes a MovieObject.bdmv (New) file and an mmm.jar (New) file as the additional playback auxiliary information. Here, the word “(New)” in the MovieObject.bdmv (New) file indicates that the file is the additional playback auxiliary information acquired separately from content by the transmission/reception unit 208. That is to say, the MovieObject.bdmv (New) file is the additional playback auxiliary information acquired by the transmission/reception unit 208 as a response to the request for the playback auxiliary information made to the content distribution device 103 because a size of the MovieObject.bdmv file having been recorded on the BDa is 0 and a playback device not having the Java environment cannot display a menu screen.

A menu screen generated by using the hhh.jar file here is as illustrated in FIG. 11, for example, as previously described. In contrast, a menu screen generated by using the MovieObject.bdmv (New) file is as illustrated in FIG. 12, for example. As described above, the menu screen generated by using the MovieObject.bdmv (New) file is simpler than the menu screen generated by using the hhh.jar file, and is displayable by a playback device not including a display mechanism having high-load and rich environment such as the Java environment.

Similarly to the MovieObject.bdmv (New) file, the mmm.jar file is the additional playback auxiliary information acquired separately from the content by the transmission/reception unit 208. The mmm.jar file is a file acquired by the transmission/reception unit 208 even though the content “aaa.m2ts” is associated with the default playback auxiliary information indicated as the hhh.jar file and executed in the Java environment. The mmm.jar file is a special file for those who have paid an extra fee. The mmm.jar file is the additional playback auxiliary information used to generate, for example, a more advanced menu screen than a menu screen generated by using the hhh.jar file or a special menu screen including a premium image that is different from a normal image.

The management unit 214 manages content pieces in the same format as one group of content pieces. The management unit 214 further assigns the same use condition to content pieces in the same application format. By way of example, in the present embodiment, content pieces belonging to the same media type are managed as the content pieces in the same format. For example, out of a plurality of content pieces stored in the HDD 217, one or more content pieces in a BDMV format (e.g. in an xxx.m2ts format) are managed as one group of content pieces, and use conditions corresponding to a BD (the number of taking out content: three times and usable period: unlimited) included in the use condition information illustrated in FIG. 10 are assigned to each of the one or more content pieces in the BDMV format. Similarly to the content pieces in the BDMV format, content pieces in an SD-VIDEO format (e.g. in an xxx.asf format) are managed as one group of content pieces, and the same use condition is assigned to these content pieces.

The playback auxiliary information generation unit 215 generates the additional playback auxiliary information that is similar to that acquired by the transmission/reception unit 208. The playback auxiliary information generation unit 215 may generate the additional playback auxiliary information when the transmission/reception unit 208 does not acquire the additional playback auxiliary information, or may generate different additional playback auxiliary information when the transmission/reception unit 208 acquires the additional playback auxiliary information. As long as the additional playback auxiliary information is reliably acquired by the transmission/reception unit 208, the playback auxiliary information generation unit 215 may not generate the additional playback auxiliary information. The additional playback auxiliary information generated by the playback auxiliary information generation unit 215 is information used to generate a similar menu screen to that illustrated in FIG. 12.

The control unit 216 manages and controls the above-mentioned units so that content is read and played back from a recording medium, content is recorded on the HDD 217 and a recording medium, and content is received and played back from a content distribution device. The control unit 216 also performs display control, for example, so that the display unit 204 displays an image showing a list of content pieces available for playback and for being taken out from among content pieces stored in the HDD 217.

1.3 Playback Devices 108 and 109

The playback device 108 reads content and additional playback auxiliary information from the recording medium 106, generates a menu screen by using the read additional playback auxiliary information and plays back the read content.

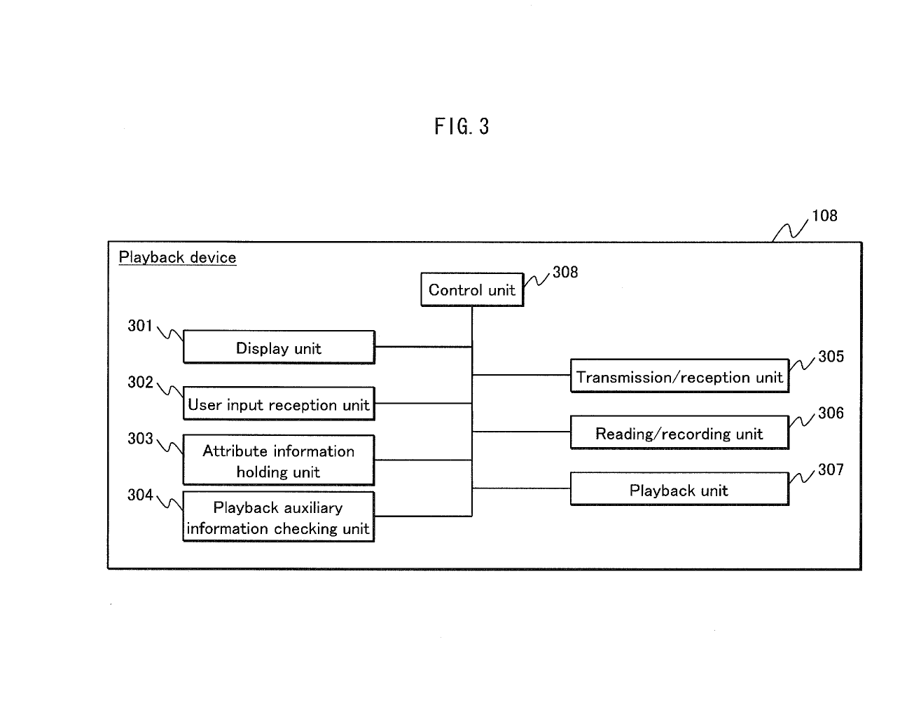

FIG. 3 is a block diagram illustrating a configuration of the playback device 108.

As illustrated in FIG. 3, the playback device 108 includes a display unit 301, a user input reception unit 302, an attribute information holding unit 303, a playback auxiliary information checking unit 304, a transmission/reception unit 305, a reading/recording unit 306, a playback unit 307 and a control unit 308.

The display unit 301 includes a display screen and a display control unit (not illustrated) for controlling a display on the display screen. The display unit 301 displays, for example, a list of content pieces recorded on the recording medium 106 on the display screen.

The user input reception unit 302 receives an instruction from a user provided through input operation on a keypad (not illustrated), and notifies the control unit 308 of the received instruction. For example, the user input reception unit 302 receives, from a user, an instruction specifying one content piece selected from the list of content pieces recorded on the recording medium 106, which is displayed by the display unit 301.

The attribute information holding unit 303 holds therein attribute information indicating a content format supported by the playback device 108 and types of the default playback auxiliary information and the additional playback auxiliary information used by the playback device 108 to perform playback. Specifically, the attribute information indicates whether or not the playback device 108 complies with each of the BDMV, SD-VIDEO, BD-J and HDMV formats, has the Java environment and includes other mechanisms such as a playback mechanism and a display mechanism.

As for each content piece specified by the instruction received from a user by the user input reception unit 302 from among content pieces recorded on the recording medium 106, the playback auxiliary information checking unit 304 judges whether or not a type of the playback auxiliary information recorded on the recording medium 106 matches any of types of the playback auxiliary information indicated by the attribute information held in the attribute information holding unit 303.

The playback auxiliary information checking unit 304 judges that it is possible to display a menu screen by using the playback auxiliary information concerning the content when they match, and judges that it is not possible to display the menu screen when they do not match.

When display of the menu screen is judged to be possible, the playback unit 307 reads the playback auxiliary information from a predetermined reading location on the recording medium 106 and processes the read playback auxiliary information to generate the menu screen, and the display unit 204 displays the generated menu screen. When display of the menu screen is judged to be impossible, the display unit 201 displays an error message such as “playback is not possible.”

The reading/recording unit 306 reads content and additional playback auxiliary information recorded on the recording medium 106, and writes the read content and additional playback auxiliary information. The reading/recording unit 306 also generates a list of content pieces recorded on the recording medium 106. Note that a description of an encryption unit and a decryption unit included in the playback device 108, which are respectively similar to the encryption unit 211 and the decryption unit 209 included in the playback/recording device 105, is omitted here. These units, however, are included in the reading/recording unit 306 and perform encryption and decryption accordingly as necessary.

The playback unit 307 plays back the content read by the reading/recording unit 306. In this case, similarly to the playback unit 203 included in the playback/recording device 105, the playback unit 307 updates the usage status information indicating a usage status of content, and stops using the content when the usage status does not satisfy a use condition. Furthermore, the playback unit 307 records the usage status information indicating a usage status of content on the recording medium 106 when the usage status information is not recorded on the recording medium 106, and updates the usage status information when the usage status information is recorded on the recording medium 106. The usage status information is recorded so as to be tamper-resistant, or is recorded after a digital signature is attached thereto so that manipulation detection becomes possible.

The control unit 308 manages and controls the above-mentioned units so that content is read and played back from a recording medium and the playback auxiliary information is recorded on a recording medium.

Note that the playback device 109 has a similar configuration to the playback device 108, and thus a description thereof is omitted.

2. Operation

2.1. Storage of Content in HDD 217 Performed by Playback/Recording Device 105

The following describes operation performed by the playback/recording device 105 to store content having been recorded on the recording medium 104 in the HDD 217.

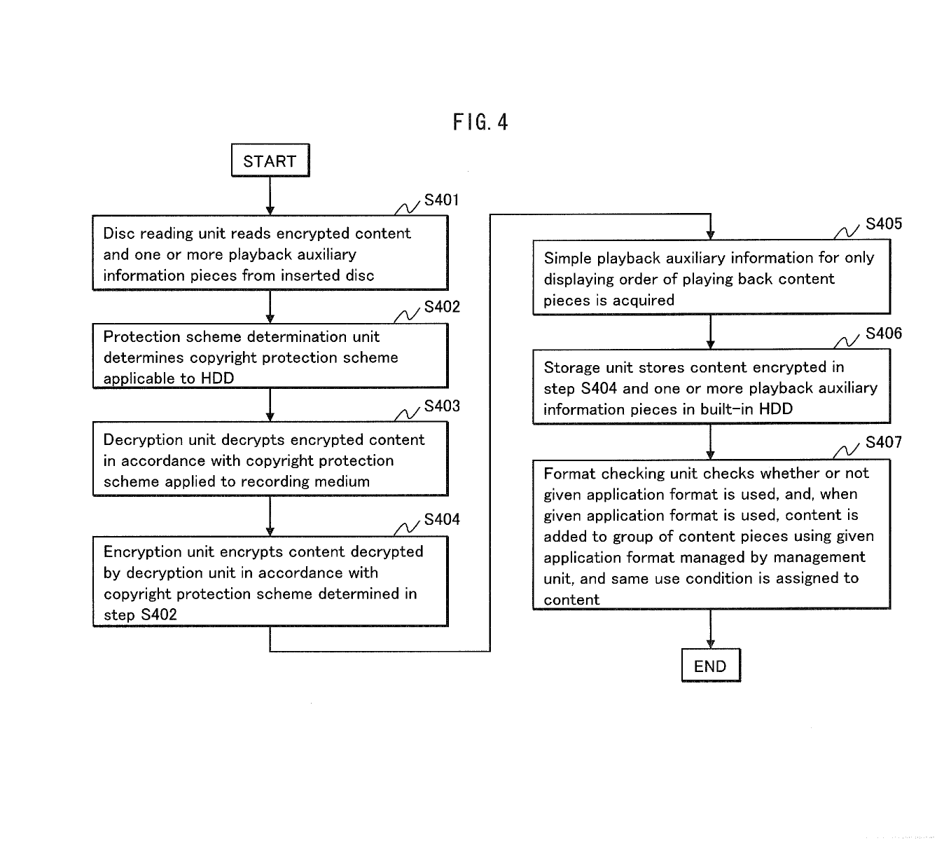

FIG. 4 is a flow chart showing the operation to store content having been recorded on the recording medium 104 in the HDD 217.

First, the input/output unit 201 reads encrypted content and one or more default playback auxiliary information pieces from an inserted disc (step S401.)

The protection scheme determination unit 210 determines a copyright protection scheme applicable to the HDD 217 (step S402.) By way of example, an AES encryption scheme is determined as the applicable copyright protection scheme here.

Next, the decryption unit 209 decrypts the protected encrypted content in accordance with a copyright protection scheme applied to the recording medium 104 (step S403.) In the present embodiment, the content recorded on the recording medium 104 has been encrypted in accordance with an AACS scheme. Therefore, the decryption unit 209 decrypts the encrypted content in accordance with the AACS scheme.

The encryption unit 211 encrypts the content decrypted by the decryption unit 209 in accordance with the copyright protection scheme (AES encryption scheme) determined in the step S402 (step S404.) Next, the additional playback auxiliary information, which is simple playback auxiliary information for only displaying an order of playing back content pieces, is acquired (step S405.) In this embodiment, the additional playback auxiliary information is received by the transmission/reception unit 208 from the outside (e.g. from the content distribution device 103.) Alternatively, the playback auxiliary information generation unit 215 may generate the additional playback auxiliary information to acquire the additional playback auxiliary information. A plurality of additional playback auxiliary information pieces may be acquired through both of reception and generation.

The storage unit 202 stores all of the content encrypted in the step S404, the default playback auxiliary information and the additional playback auxiliary information in the HDD 217 (step S406.)

The format checking unit 213 checks whether or not a given application format (e.g. an application format used in a Blu-ray disc) is used. When the given application format is used, the content is added to a group of content pieces using the given application format managed by the management unit 214, and the same use condition is assigned to the content (step S407.)

Following the assignment, the use condition pertaining to the use condition information illustrated, as an example, in FIG. 10 is employed when the content is used.

2.2. Recording of Content on Recording Medium Performed by Playback/Recording Device 105

The following describes operation performed by the playback/recording device 105 to record content stored in the HDD 217 on the recording medium 106 or the recording medium 107.

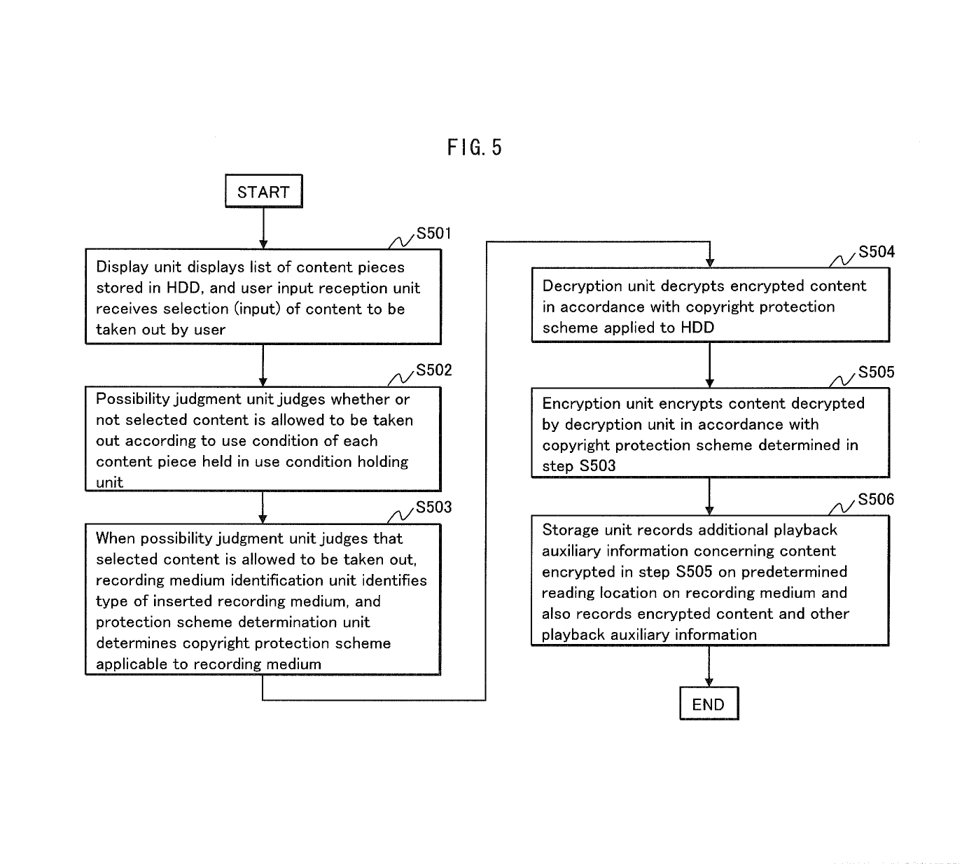

FIG. 5 is a flow chart showing operation to write content stored in the HDD 217 into a recording medium.

First, the display unit 201 displays a list of content pieces stored in the HDD 217. In this case, the user input reception unit 206 receives selection (input) of content that a user wishes to take out (step S501.)

Next, the possibility judgment unit 207 judges whether or not the selected content is allowed to be taken out according to a use condition of each content piece held in the use condition holding unit 205 (step S502.) When the possibility judgment unit 207 judges that the selected content is allowed to be taken out, the recording medium identification unit 212 identifies a type of an inserted recording medium. The protection scheme determination unit 210 determines a protection scheme applicable to the recording medium identified by the recording medium identification unit 212 (step S503.)

Next, the decryption unit 209 decrypts the protected encrypted content in accordance with a copyright protection scheme applied to the HDD 217 (step S504.)

The encryption unit 211 encrypts the content decrypted by the decryption unit 209 in accordance with the protection scheme determined in the step S503 (step S505.)

The storage unit 202 records, via the input/output unit 201, the additional playback auxiliary information concerning the content encrypted in the step S505 on a predetermined reading location on a recording medium used to take out the content. The storage unit 202 also records the encrypted content and the playback auxiliary information (the default playback auxiliary information and the additional playback auxiliary information) concerning the content (step S506.)

2.3 Playback of Content Recorded on Recording Medium Performed by Playback Devices 108 and 109

The following describes operation performed by the playback device 108 to play back content recorded on the recording medium 106.

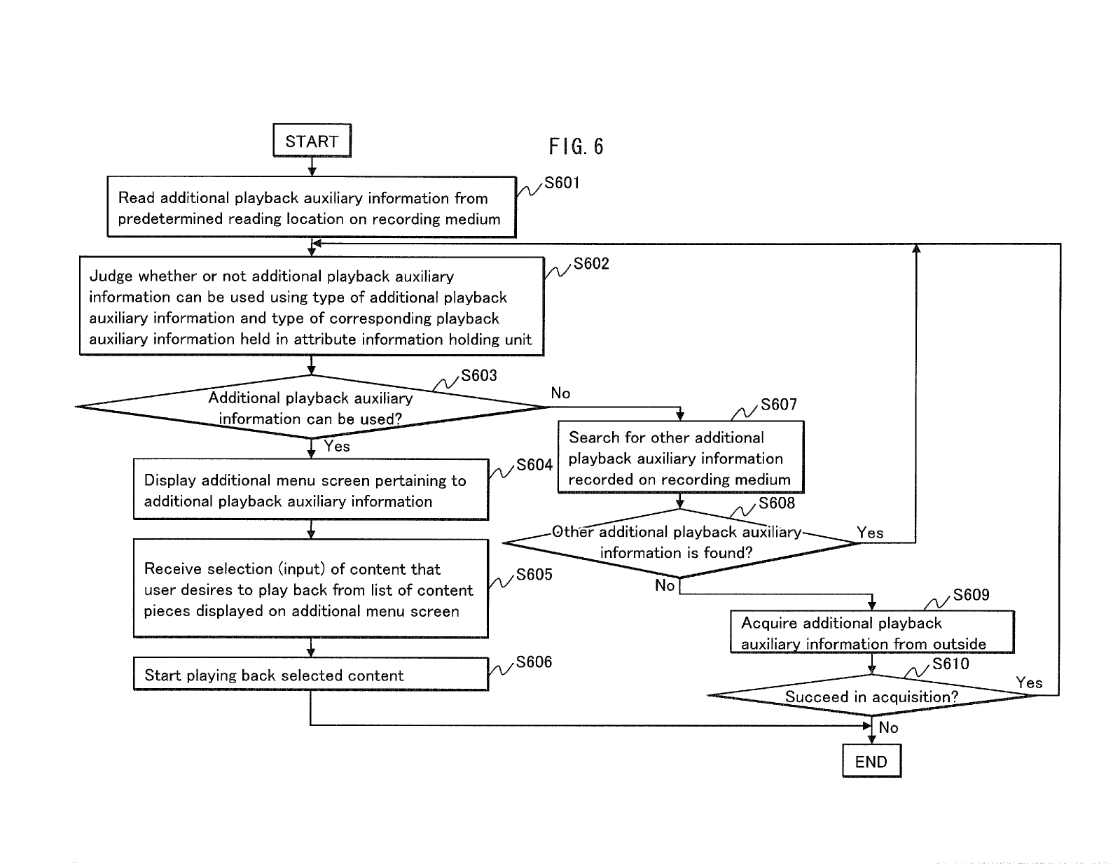

FIG. 6 is a flow chart showing operation to play back content recorded on the recording medium 106.

First, the reading/recording unit 306 reads, from a predetermined reading location on the recording medium 106, the additional playback auxiliary information recorded thereon (step S601.)

Next, the playback auxiliary information checking unit 304 compares a type of the read additional playback auxiliary information with a type of a corresponding playback auxiliary information held in the attribute information holding unit 303, and judges whether or not the additional playback auxiliary information pertaining to the content can be used (step S602.)

When the read additional playback auxiliary information is judged to be used (Yes in step S603), the playback unit 307 interprets the read additional playback auxiliary information to generate the additional menu screen and causes the display unit 301 to display the generated additional menu screen (step S604.) On the additional menu screen, a list of content pieces available for playback is displayed.

The user input reception unit 302 receives selection (input) of content from a user (step S605), and the playback unit 307 plays back the selected content (step S606.) On the other hand, when the read additional playback auxiliary information is judged not to be used (No in step S603), the reading/recording unit 306 searches for other additional playback auxiliary information recorded on the recording medium 106 (step S607.) When the other additional playback auxiliary information is found through the search (Yes in step S609), processing in and after the step S602 is performed with respect to the found additional playback auxiliary information. When the other additional playback auxiliary information is not found through the search (No in step S608), the transmission/reception unit 305 acquires the additional playback auxiliary information suitable for the playback device 108 from the outside (e.g. from the content distribution device 103) (step S609.) When the transmission/reception unit 305 succeeds in acquiring the additional playback auxiliary information (Yes in step S610), processing in and after the step S602 is performed with respect to the acquired additional playback auxiliary information. When the transmission/reception unit 305 fails to acquire the additional playback auxiliary information (No in step S610), processing is terminated.

(Other Modifications)

Although the present invention has been described based on the above-mentioned embodiment, it is obvious that the present invention is not limited to the above-mentioned embodiment. The following cases also fall within a scope of the present invention.

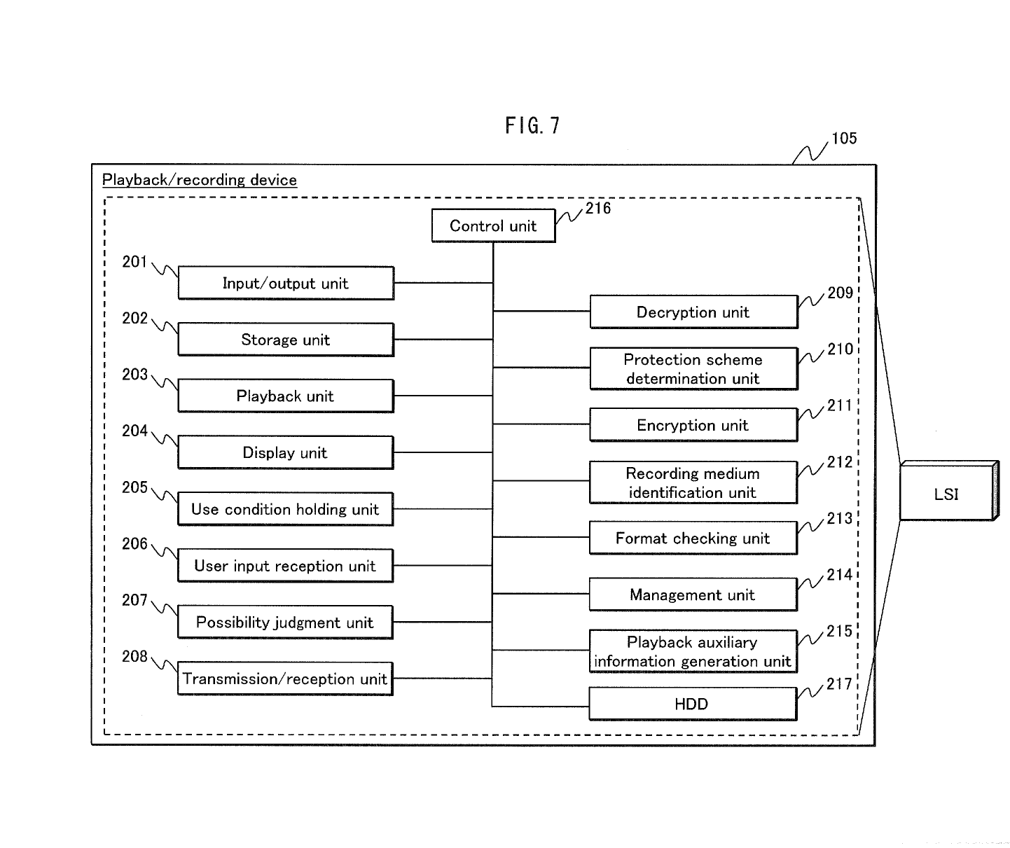

(1) Functional blocks included in the playback/recording device 105 such as the input/output unit 201, the storage unit 202, the playback unit 203, the display unit 204, the use condition holding unit 205, the user input reception unit 206, the possibility judgment unit 207, the transmission/reception unit 208, the decryption unit 209, the protection scheme determination unit 210, the encryption unit 211, the recording medium identification unit 212, the format checking unit 213, the management unit 214, the playback auxiliary information generation unit 215 and the control unit 216 are typically embodied as an LSI, which is an integrated circuit, as illustrated in FIG. 7. These units may individually be configured as a single chip, or part of one or more or each of these units may be configured as a single chip.

The same applies to each functional block included in each of the playback devices 108 and 109, such as the display unit 301, the user input reception unit 302, the attribute information holding unit 303, the playback auxiliary information checking unit 304, the transmission/reception unit 305, the reading/recording unit 306, the playback unit 307 and the control unit 308.

(2) As for the playback device 108, when the playback auxiliary information checking unit 304 judges that the playback auxiliary information recorded on a recording medium targeted for reading is not used, the playback auxiliary information that can be used may be received from the content distribution device 103.

For example, as for the playback device 108, when the attribute information held in the attribute information holding unit 303 complies only with the HDMV specification, but content selected by a user is associated with the playback auxiliary information that complies only with the BD-J specification, the playback auxiliary information that complies with the HDMV specification may be received via the transmission/reception unit 305 for use in playback and recorded on the recording media 106 and 107 via the reading/recording unit 306.

(3) In the above-mentioned embodiment, the playback/recording device is described to have a configuration in which content pieces in the same application format are managed as one group of content pieces. The present invention, however, is not limited in this way. For example, instead of the application format, data pieces in the same format that can be visually recognized by a user (i.e. a structure of a menu screen and a user interface) may be managed as one group of data pieces, and a format that cannot be visually recognized by a user (i.e. an encryption algorithm used for copyright protection and a bit length of a key) may be used by selecting a optimal or an applicable format in each case.

(4) In the above-mentioned embodiment, the playback/recording device 105 is described to have a configuration in which simple playback auxiliary information is generated when the content is read from the recording medium 104 and stored in the HDD 217. The present invention, however, is not limited in this way. The simple playback auxiliary information may be generated when the content is taken out by using the recording medium 106 or the recording medium 107. Alternatively, the playback auxiliary information may be generated based on an instruction from a user received using the user input reception unit 206.

(5) The playback/recording device 105 may have a configuration in which the playback auxiliary information is acquired based on an instruction from a user received using the user input reception unit 206 when the content is taken out by using the recording medium 106 or the recording medium 107.

(6) In the above-mentioned embodiment, the playback/recording device 105 is described to have a configuration in which the content recorded on the recording medium 104 is stored in the HDD 217 as it is. The present invention, however, is not limited in this way. For example, the playback/recording device 105 may have a configuration in which, when the content is stored in the HDD 217, the content is re-encoded and then stored in order to adjust a bit rate and resolution of the content. Furthermore, the playback/recording device 105 may have a configuration in which, when entire content is divided into a plurality of files, the plurality of files may be brought together by processing and editing.

(7) In the above-mentioned embodiment, the playback/recording device 105 is described to have a configuration in which the content recorded on the recording medium 104 is read and stored in the HDD 217. The present invention, however, is not limited in this way. For example, instead of storing the read content having been recorded on the recording medium 104 in the built-in HDD 217, the read content may directly be stored in an external HDD or an external portable medium such as an optical disc and a flash memory.

(8) In the above-mentioned embodiment, the playback/recording device 105 is described to have a configuration in which the management unit 214 assigns the same use condition to a group of content pieces in the same application format. The present invention, however, is not limited in this way. A different use condition may be assigned to each of the content pieces in the same application format. Alternatively, a different use condition may exceptionally be assigned to a particular content piece.

Furthermore, content pieces in some of a plurality of application formats may be managed as one group of content pieces. Alternatively, all content pieces may be managed as one group of content pieces irrespective of application formats, and the same use condition (e.g. a possibility of taking out content, the number of taking out content, a possibility of moving content, a possibility of performing remote playback and a playback available time) may be assigned to all content pieces.

(9) In the above-mentioned embodiment, the playback/recording device 105, the playback device 108 and the playback device 109 are each described to have a configuration in which a list of all content pieces are displayed, and whether content selected by a user instruction with reference to the list is allowed to be taken out and played back are checked and judged. The present invention, however, is not limited in this way. For example, when a user hopes to take out content (when an instruction on taking out content is input by a user,) a list of only content pieces available for being taken out may be displayed. Similarly, when a user hopes to play back content (when an instruction on displaying a list of content pieces available for playback is input by a user,) a list of only content pieces available for playback may be displayed. Even when a list of all content pieces is displayed, content pieces available for being taken out or for playback may be displayed so as to be visually identified (e.g. by coloring the content pieces or by marking each of the content pieces with an icon.)

(10) In the above-mentioned embodiment, the playback/recording device 105 is described to have a configuration in which, when the content is taken out by using the recording medium 106 and the recording medium 107, all playback auxiliary information pieces are recorded and taken out. The present invention, however, is not limited in this way. The playback/recording device 105 may have a configuration in which, when the content is taken out by using the recording medium 106 and the recording medium 107, the display unit 204 and the user input reception unit 206 receives an instruction from a user, and only playback auxiliary information piece selected by the user is taken out.

(11) In addition to the above-mentioned embodiment, the present invention may have a configuration in which, when a content piece not in a particular application format (e.g. an application format used in a Blu-ray disc) is acquired via a recording medium or via the network, the content piece is recorded after an application format of the content piece is changed to the particular application format (e.g. the application format used in a Blu-ray disc), and the playback auxiliary information to be used after the application format is changed is separately acquired (e.g. via the network.)

(12) In addition to the above-mentioned embodiment, the present invention may have a configuration in which, when the playback/recording device or the playback device complies with a plurality of formats of the playback auxiliary information (e.g. both of the BD-J specification for a Blu-ray disc and the HDMV specification), the device automatically determines the playback auxiliary information to be used based on the priority set in advance. For example, when the playback device complies with both of the BD-J specification and the HDMV specification and a recording medium has recorded thereon the playback auxiliary information that complies with both of the specifications, the playback device automatically selects and uses the BD-J specification if the BD-J specification, which is more advanced and versatile, is given higher priority than the HDMV specification in advance. The display unit and the user input reception unit may be used to ask for an instruction from a user, and playback may be performed using the playback auxiliary information selected by the user.

(13) In the above-mentioned embodiment, the playback/recording device is described to have a configuration in which encryption processing is performed in accordance with a protection scheme determined by the protection scheme determination unit. The present invention, however, is not limited in this way. The present invention may have a configuration in which a copyright protection scheme conversion unit including the encryption unit and the decryption unit is provided and the copyright protection scheme conversion unit converts a copyright protection scheme to that applied to the built-in HDD or a recording medium for recording content based on the determination made by the protection scheme determination unit.

(14) In the above-mentioned embodiment, one device is configured to have a plurality of functions (components). The present invention, however, is not limited in this way. A case where these functions (components) are divided into a plurality of devices and a combination thereof achieves similar effects and functions also falls within a scope of the present invention.

(15) Each of the above-mentioned devices is specifically a computer system composed of a microprocessor, a ROM, a RAM, a hard disk unit, a display unit, a keyboard, a mouse and the like. A computer program is stored in the RAM or the hard disk unit. By the microprocessor operating in accordance with the computer program, each of the devices achieves its function. The computer program here is composed of a combination of a plurality of instruction codes each instructing the computer to achieve a predetermined function.

Note that each of the devices is not limited to the computer system composed of all of the microprocessor, the ROM, the RAM, the hard disk unit, the display unit, the keyboard, the mouse and the like, and may be a computer system composed of a part of them.

(16) A part or all of the components constituting each of the above-mentioned devices may be configured as a circuit for achieving functions of the components, as a program for achieving functions of the components and a processor for executing the program, or as a single system LSI (Large Scale Integration.) The system LSI is a super-multifunctional LSI manufactured by integrating a plurality of components on a single chip, and is specifically a computer system composed of a microprocessor, a ROM, a RAM and the like. A computer program is stored in the RAM. By the microprocessor operating in accordance with the computer program, the system LSI achieves its functions. Each of the components constituting each of the above-mentioned devices may be configured as a single chip, or part or all thereof may be configured as a single chip.

Although the system LSI is taken as an example here, it may be referred to as an IC, a system LSI, a super LSI, or an ultra LSI depending on the degree of integration.

Also, a method of forming integrated circuits is not limited to LSIs, and may be realized using a dedicated circuit or a general-purpose processor. It is possible to form integrated circuits with use of an FPGA (Field Programmable Gate Array) programmable after manufacturing LSIs or a reconfigurable processor in which connection and setting of the circuit cell within an LSI can be reconfigured.

Furthermore, if technology for forming integrated circuits that replaces LSIs emerges owing to advances in semiconductor technology or to another derivative technology, function blocks may be formed as integrated circuits using such technology. The application of biotechnology or the like is possible.

(17) A part or all of the components constituting each of the above-mentioned devices may be constructed from an IC card or a single module attachable/detachable to and from each device. The IC card and the module are each a computer system composed of a microprocessor, a ROM, a RAM and the like. The IC card and the module each may include the above-mentioned super-multifunctional LSI. By the microprocessor operating in accordance with the computer program, the IC card and the module each achieve its functions. The IC card and the module each may be tamper resistant.

(18) The present invention may be a method described above. Also, the present invention may be a computer program that causes a computer to achieve the method, or may be a digital signal composed of the computer program.

Furthermore, the present invention may be a computer-readable recording medium such as a flexible disk, a hard disk, a CD-ROM, an MO, a DVD, a DVD-ROM, a DVD-RAM, a BD and a semiconductor memory having been recorded thereon the computer program or the digital signal. The present invention may be the computer program or the digital signal recorded on any of these recording media.

Also, the present invention may be implemented by transmitting the computer program or the digital signal via an electric communication line, a wireless or a wired communication line, a network represented by the internet, a data broadcast and the like.

Also, another independent computer system may implement the present invention by transferring the recording medium recorded thereon the computer program or the digital signal, or by transferring the computer program or the digital signal via the network and the like.

(19) The above-mentioned embodiment and modifications may be combined with one another.

### INDUSTRIAL APPLICABILITY

The content providing system, the recording device and the recording method pertaining to the present invention are useful in the industry that provides users with digital content, the manufacturing industry that manufactures a device for receiving or playing back the digital content, and the sales industry that sells the device for receiving or playing back the digital content.

### REFERENCE SIGNS LIST

101 content production device
102 disc manufacturing device
103 content distribution device
104 recording medium
105 playback/recording device
106 recording medium
107 recording medium
108 playback device
109 playback device

1-11. (canceled)

12. A content recording device that records, on a recording medium, content and first playback auxiliary information used to generate a default menu screen for playing back the content, the content recording device comprising:
a content acquisition unit configured to acquire the content and the first playback auxiliary information;
a playback auxiliary information acquisition unit configured to make a request for second playback auxiliary information used to generate a substitute menu screen to a server device and receive the second playback auxiliary information from the server device as a response to the request, the substitute menu screen being displayable by a display mechanism different from a display mechanism for displaying the default menu screen; and
a writing unit configured to write the content, the first playback auxiliary information and the second playback auxiliary information into the recording medium.

13. The content recording device of claim 12, wherein
a processing load of displaying the substitute menu screen generated by using the second playback auxiliary information is less than a processing load of displaying the default menu screen generated by using the first playback auxiliary information.

14. The content recording device of claim 13, wherein
the default menu screen generated by using the first playback auxiliary information is more interactive than the substitute menu screen generated by using the second playback auxiliary information, and
the substitute menu screen generated by using the second playback auxiliary information is used to display a list of content pieces available for playback, receive selection of one content piece from the list, and non-interactively play back the one content piece.

15. The content recording device of claim 12, wherein
the playback auxiliary information acquisition unit is further configured to generate the second playback auxiliary information to acquire the second playback auxiliary information.

16. The content recording device of claim 12, wherein
the playback auxiliary information acquisition unit further acquires one or more other playback auxiliary information pieces, and
the content recording device further comprising:
a display unit configured to display a list of all the playback auxiliary information pieces acquired by the content acquisition unit and the playback auxiliary information acquisition unit; and
a reception unit configured to receive, from a user, an instruction specifying one or more playback auxiliary information pieces to be written into the recording medium from the list, and
the writing unit writes the specified one or more playback auxiliary information pieces into the recording medium.

17. The content recording device of claim 12, wherein
the content acquisition unit further acquires one or more other content pieces, and
the content recording device further comprising:
a format checking unit configured to check a format of each of all the acquired content pieces; and
a management unit configured to manage the acquired content pieces by attaching a same use condition to content pieces in a same format irrespective of whether or not a use condition has been attached to each of the acquired content pieces.

18. A content recording method for recording, on a recording medium, content and first playback auxiliary information used to generate a default menu screen for playing back the content, the content recording method comprising:
a content acquisition step of acquiring the content and the first playback auxiliary information;
a playback auxiliary information acquisition step of making a request for second playback auxiliary information used to generate a substitute menu screen to a server device and receiving the second playback auxiliary information from the server device as a response to the request, the substitute menu screen being displayable by a display mechanism different from a display mechanism for displaying the default menu screen; and
a writing step of writing the content, the first playback auxiliary information and the second playback auxiliary information into the recording medium.

19. A content recording program for use by a content recording device that records, on a recording medium, content and first playback auxiliary information used to generate a default menu screen for playing back the content, the content recording program comprising:
a content acquisition step of acquiring the content and the first playback auxiliary information;
a playback auxiliary information acquisition step of making a request for second playback auxiliary information used to generate a substitute menu screen to a server device and receiving the second playback auxiliary information from the server device as a response to the request, the substitute menu screen being displayable by a display mechanism different from a display mechanism for displaying the default menu screen; and
a writing step of writing the content, the first playback auxiliary information and the second playback auxiliary information into the recording medium.

20. A computer-readable recording medium having recorded thereon a content recording program for use by a content recording device that records, on a recording medium, content and first playback auxiliary information used to generate a default menu screen for playing back the content, wherein
the content recording program comprising:
a content acquisition step of acquiring the content and the first playback auxiliary information;
a playback auxiliary information acquisition step of making a request for second playback auxiliary information used to generate a substitute menu screen to a server device and receiving the second playback auxiliary information from the server device as a response to the request, the substitute menu screen being displayable by a display mechanism different from a display mechanism for displaying the default menu screen; and
a writing step of writing the content, the first playback auxiliary information and the second playback auxiliary information into the recording medium.

21. An integrated circuit that records, on a recording medium, content and first playback auxiliary information used to generate a default menu screen for playing back the content, the integrated circuit comprising:
a content acquisition unit configured to acquire the content and the first playback auxiliary information;
a playback auxiliary information acquisition unit configured to make a request for second playback auxiliary information used to generate a substitute menu screen to a server device and receive the second playback auxiliary information from the server device as a response to the request, the substitute menu screen being displayable by a display mechanism different from a display mechanism for displaying the default menu screen; and
a writing unit configured to write the content, the first playback auxiliary information and the second playback auxiliary information into the recording medium.

22. A content recording/playback system including a content recording device and a playback device, wherein
the content recording device comprising:
a content acquisition unit configured to acquire the content and the first playback auxiliary information used to generate a default menu screen for playing back the content;
a playback auxiliary information acquisition unit configured to make a request for second playback auxiliary information used to generate a substitute menu screen to a server device and receive the second playback auxiliary information from the server device as a response to the request, the substitute menu screen being displayable by a display mechanism different from a display mechanism for displaying the default menu screen; and
a writing unit configured to write the content, the first playback auxiliary information and the second playback auxiliary information into the recording medium, and
the playback device
includes the different display mechanism, and
reads the second playback auxiliary information from the recording medium and displays the substitute menu screen generated by using the read second playback auxiliary information.
